(19) United States
(12) Patent Application Publication
(10) Pub. No.: US 2015/0244466 A1
(43) Pub. Date: Aug. 27, 2015

(54) OPTICAL SENDING CIRCUIT AND OPTICAL SENDING METHOD

(71) Applicant: NEC Corporation, Minato-ku, Tokyo (JP)

(72) Inventors: Daisuke Okamoto, Tokyo (JP); Junichi Fujikata, Tokyo (JP)

(21) Appl. No.: 14/423,196

(22) PCT Filed: Aug. 26, 2013
(86) PCT No.: PCT/JP2013/005005

§ 371 Date: Feb. 23, 2015

(30) Foreign Application Priority Data
Aug. 29, 2012 (JP) 2012-188834

(51) Int. Cl. H04B 10/54; H04B 10/564; H04B 10/27

(52) U.S. Cl. CPC H04B 10/54; H04B 10/27; H04B 10/564

(57) ABSTRACT

In order to provide an optical sending circuit which has a small size and can carry out long haul transmission and which can reduce a stray light and an optical cross talk noise generated in an optical transmission line, the optical sending circuit includes: a first EA modulator whose reverse bias voltage is changed by a first data signal; a second EA modulator whose reverse bias voltage is changed by a second data signal; a first optical transmission line which inputs a light to be modulated, which is to be modulated by the first EA modulator, to the first EA modulator; a second optical transmission line which is connected with an output of the first EA modulator, and transfers an optical signal modulated by the first data signal; and a third optical transmission line which is connected with an output of the second EA modulator.

### TECHNICAL FIELD

The present invention relates to an optical sending circuit and an optical sending method.

### BACKGROUND ART

An optical communication system or an optical interconnection uses an external modulation system in order to reduce problems on chirping and reliability of a semiconductor laser direct modulation system. In the case of the external modulation system, modulation is carried out by use of an optical modulator different from the semiconductor laser. As an optical modulator which uses a semiconductor, the electro absorption (hereinafter, referred to as ‘EA’) type optical modulator, which carries out the optical intensity modulation by use of an effect that a light absorption wavelength shifts toward a long wavelength side according to an applied voltage, is known. The EA modulator changes a light absorption ratio by use of the Franz-Keldysh effect in the bulk semiconductor and the quantum-confined Stark effect in the multi-quantum well structure. Both of the Franz-Keldysh effect and the quantum-confined Stark effect are phenomena that the light absorption ratio of the semiconductor is changed by applying an electric field. A patent literature 1 describes an EA modulator which uses the group III-V compound semiconductor.

Moreover, in recent years, by fabricating an optical integrated circuit by use of process technology of Si-CMOS (silicon complementary metal oxide semiconductor) circuit, it is expected to realize an optical interconnect apparatus with superior performance and a cheap cost. With respect to the Si optical integrated circuit, the EA modulator using a Si waveguide path and SiₓGe₁₋ₓ (0≦x≦1), which are able to be integrated in a monolithic form, has been proposed from a point of view of integration process consistency, cost, yield and the like. SiₓGe₁₋ₓ is semiconductor material which is also called silicon germanium (hereinafter described as ‘SiGe’).

For example, a non-patent literature 1 discloses an EA modulator which uses the Franz-Keldysh effect of SiGe. The EA modulator is realized by conducting light from the Si waveguide path to a SiGe light absorption layer using a bat joint. Moreover, a non-patent literature 2 discloses an EA modulator which uses the quantum-confined Stark effect of Ge/SiGe multi-quantum well. Since these EA modulators can carry out modulation by use of an element which has a relatively short length, it is possible to realize a small optical sending circuit.

The EA modulators which are disclosed in the patent literature 1 and the non-patent literatures 1 and 2 mentioned above carry out the intensity modulation by use of a change in a light absorption coefficient of the semiconductor. Therefore, an optical output of the EA modulator is a single end signal which is generated by the intensity-modulation.

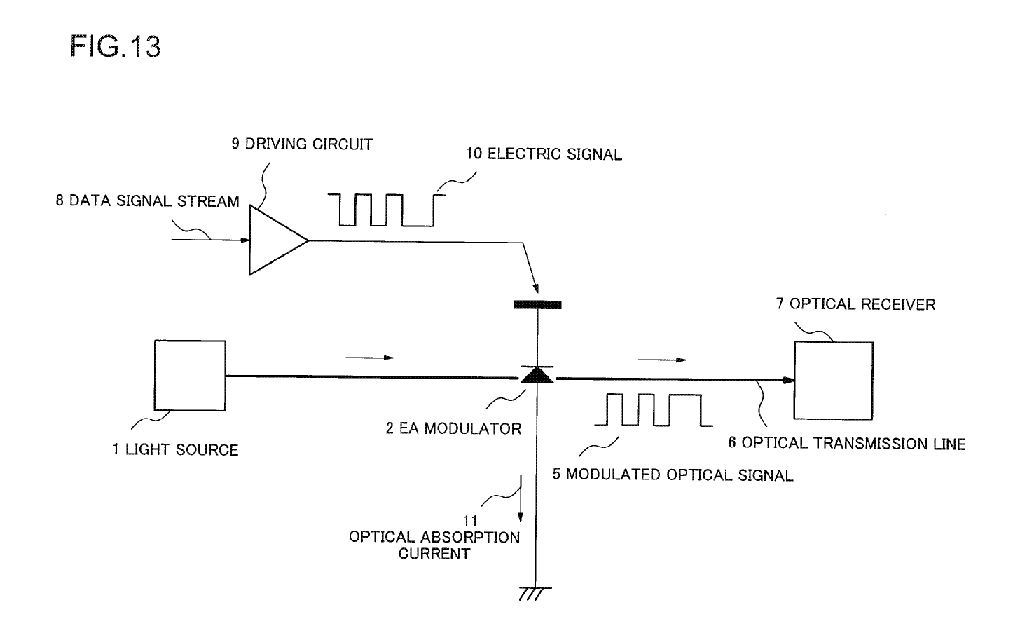

FIG. 13 is a diagram showing a configuration of an optical transmission system which is related to the present invention. A data signal stream 8 is converted into an input electric signal 10 by a driving circuit 9, and the electric signal 10 is inputted to an EA modulator 2. An input light, which is outputted by a light source 1, is modulated by the electric signal 10 in the EA modulator 2. An optical signal, which is generated by modulating the input light, is outputted as a modulated optical signal 5. The modulated optical signal 5 is transmitted through an optical transmission line 6, and is converted into an electric signal by an optical receiver 7. Here, an EA modulator 3 generates a light absorption current 11 when carrying out the modulation.

Furthermore, a patent literature 2, which is related to the invention of the present application, describes a configuration of an optical transmitter which propagates optical light signals having a normal phase and a reverse phase (differential optical signal) by use of two EA modulators. A patent literature 3 describes a configuration of regenerating a data signal from an inputted differential optical signal. Even in the case that it is necessary to convert an output signal of an optical receiving circuit into a differential electric signal, a single-differential conversion circuit in an optical receiver becomes unnecessary by transmitting the optical signals as the differential signal.

Moreover, there is a case that a light from the outside which has no relation with communication (stray light), or a light which leaks from another optical transmission line (cross talk light) intrudes into an optical transmission line. The stray light and the cross talk light lower the signal to noise ratio of the modulated optical signal, and cause degradation of transmission quality. According to a transmission method using the differential optical transmitter, it is possible to reduce influence on the transmission quality, which is caused by the stray light and the cross talk light, by using the differential optical receiver.

### CITATION LIST

### Patent Literature

[PTL 1] Japanese Patent Publication No. 3009037

[PTL 2] Japanese Patent Application Laid-Open No. 2009-063835

[PTL 3] Japanese Patent Application Laid-Open No. 2010-219651

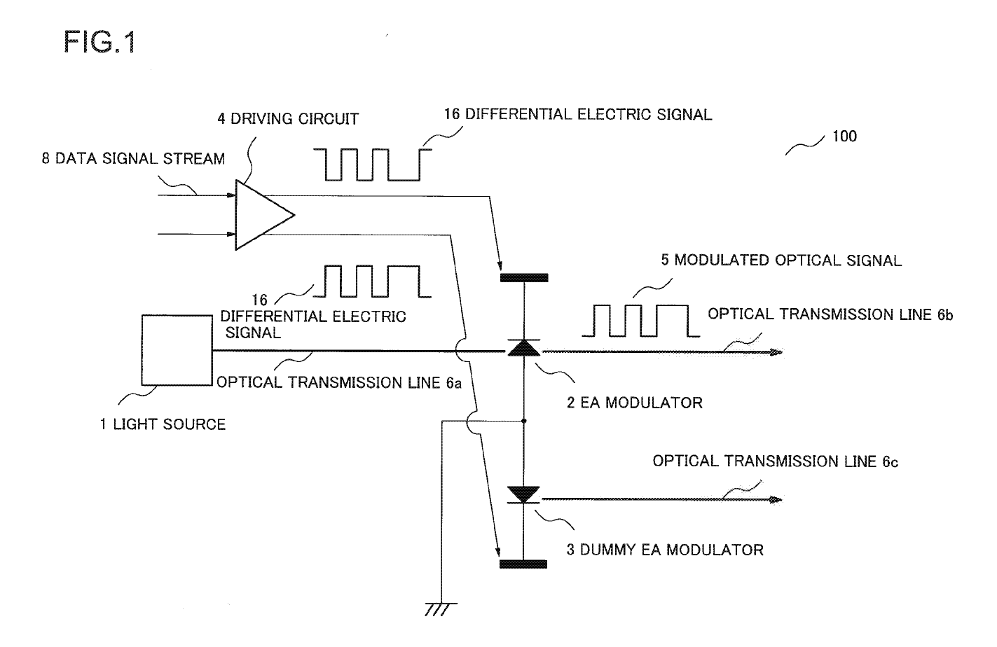

### Non-Patent Literature

[NPL 1] Jifeng Liu et al., Waveguide-integrated, ultralow-energy GeSi electro-absorption modulators, Nature Photonics 2, pp. 433-437 (2008) (FIG. 1).

[NPL 2] Yu-Hsuan Kuo et al., Quantum-Confined Stark Effect in Ge/SiGe Quantum Wells on Si for Optical Modulators, IEEE Journal of selected topics in quantum electronics 12, pp. 1503-1513 (2006) (FIG. 1).

### SUMMARY OF INVENTION

### Technical Problem

The optical transmitter (hereinafter, referred to as ‘single optical transmitter’) using only one EA modulator 2 described in FIG. 13 has a problem that the single optical transmission is apt to receive influence caused by the stray light which intrudes from the outside into the optical transmission line 6, and the cross talk noise light which intrudes from another optical transmission line existing near. It is because noise, which is caused by the stray light and the cross talk light intruding from the optical transmission line existing near, is inputted to the optical receiver 7 as it is, and causes the degradation of signal to noise ratio of the optical signal. In particular, in the case of an optical transmitter having a configuration that a plurality of EA modulators are integrated in a form of an array, the optical cross talk is apt to cause a problem.

Moreover, in the case that it is desirable that an input signal to an optical sending circuit is a differential electric signal, and an output signal of an optical receiver is also a differential electric signal, when the single optical transmitter is used as an optical transmitter, it is necessary to install a conversion circuit, which carries out single-differential conversion, in a receiving circuit. Therefore, there is a problem that a circuit configuration of the optical receiver becomes complicated, and consequently a circuit size of the optical receiver becomes large.

On the other hand, in the case of a differential optical transmitter which transmits a differential light signal by use of two EA modulators, it is necessary to divides an input light, which is generated by a light source, into two branch lights and to input each of the two branch lights to each of the two EA modulators. Therefore, an optical output power of the differential optical transmitter is about half of an optical output power of the single optical transmitter under the condition that the same light source is used. As a result, the differential optical transmitter has a problem that transmission distance becomes shorter than transmission distance of the single optical transmitter.

### OBJECT OF THE INVENTION

An object of the present invention is to provide an optical sending circuit and an optical sending method which have simple composition and can carry out long haul transmission, and which can reduce the stray light and the optical cross talk noise generated through the optical transmission line.

### Solution to Problem

An optical sending circuit of the present invention includes: a first semiconductor electro absorption type optical modulator (EA modulator) whose reverse bias voltage is changed by a first data signal; a second EA modulator whose reverse bias voltage is changed by a second data signal; a first optical transmission line which inputs a light to be modulated, which is to be modulated by the first EA modulator, into the first EA modulator; a second optical transmission line which is connected with an output of the first EA modulator and transfers an optical signal which is generated through modulation carried out by the first data signal; and a third optical transmission line which is connected with an output of the second EA modulator.

An optical sending method of the present invention is characterized by comprising: making a first data signal change a reverse bias voltage of a first semiconductor electro absorption type optical modulator (EA modulator); making a second data signal change a reverse bias voltage of a second EA modulator; inputting a light to be modulated, which is to be modulated by the first EA modulator, to the first EA modulator through a first optical transmission line; connecting a second optical transmission line with an output of the first EA modulator; and connecting a third optical transmission line with an output of the second EA modulator.

### Advantageous Effects of Invention

The optical sending circuit of the present invention can carry out long haul transmission with a simple configuration and provides an effect that it is possible to reduce the stray light and the optical cross talk noise which are generated through the optical transmission line.

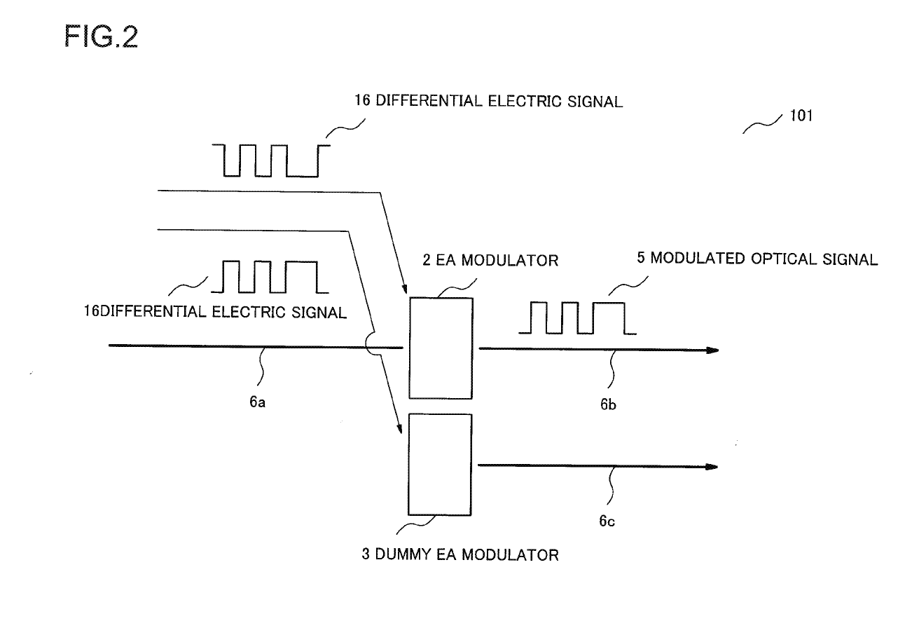

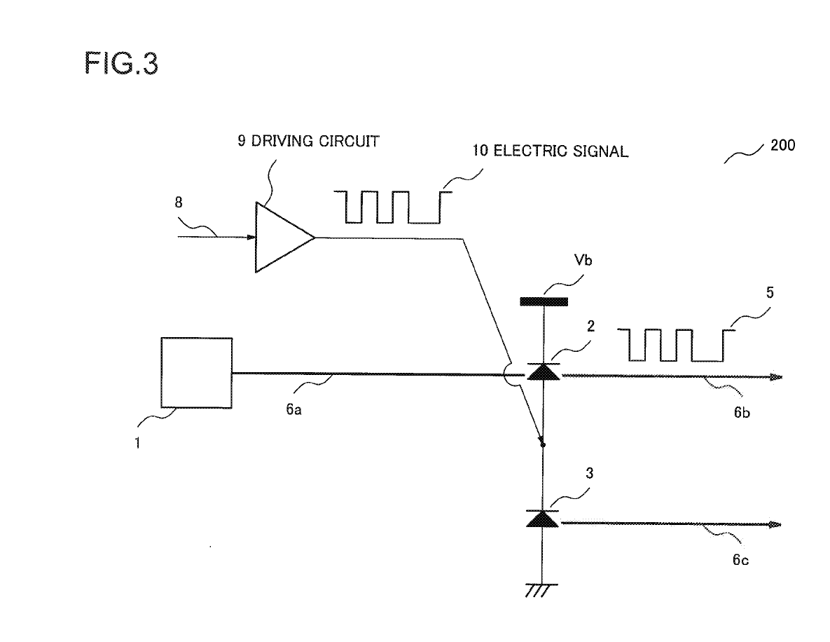

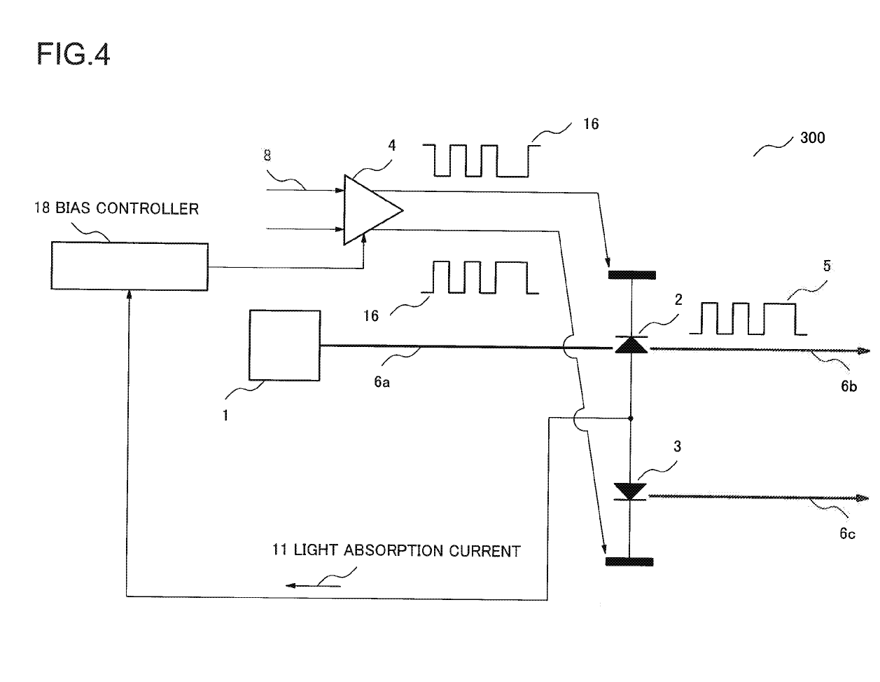

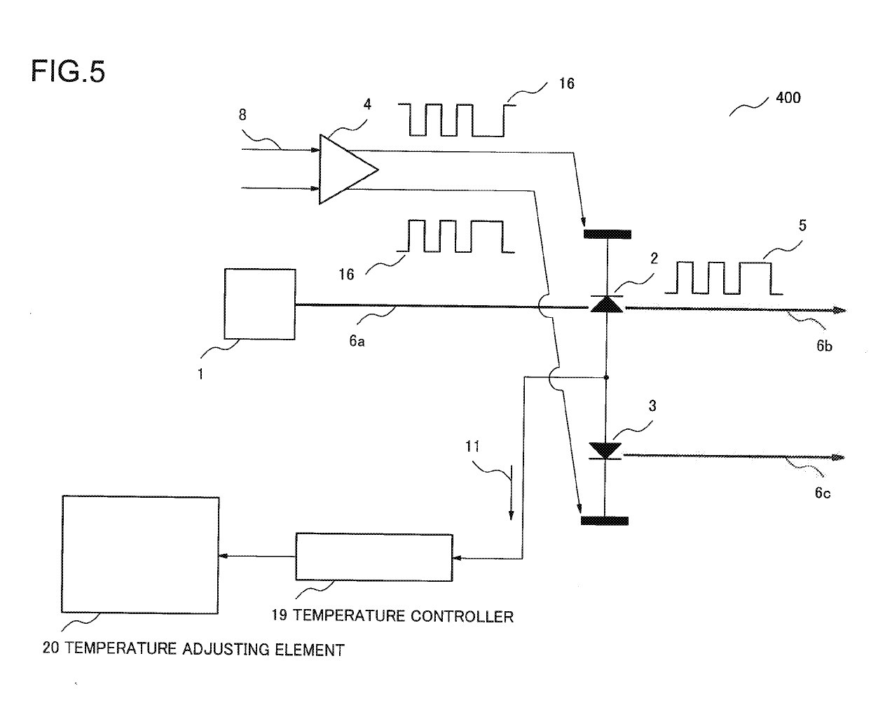

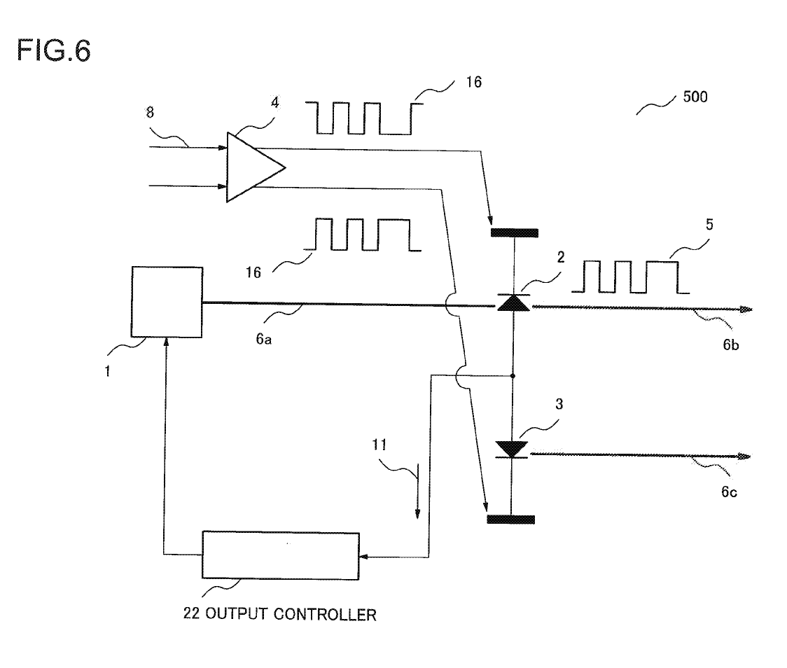

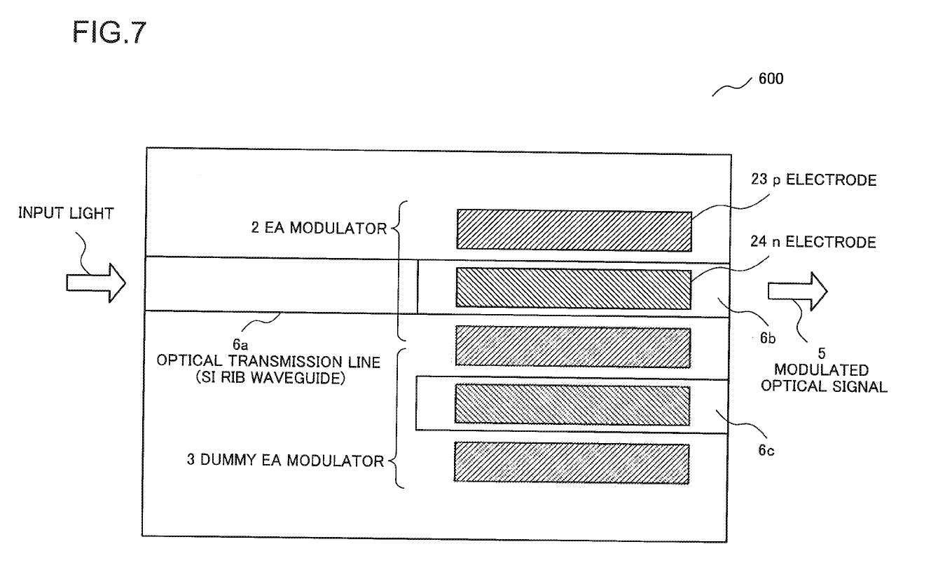

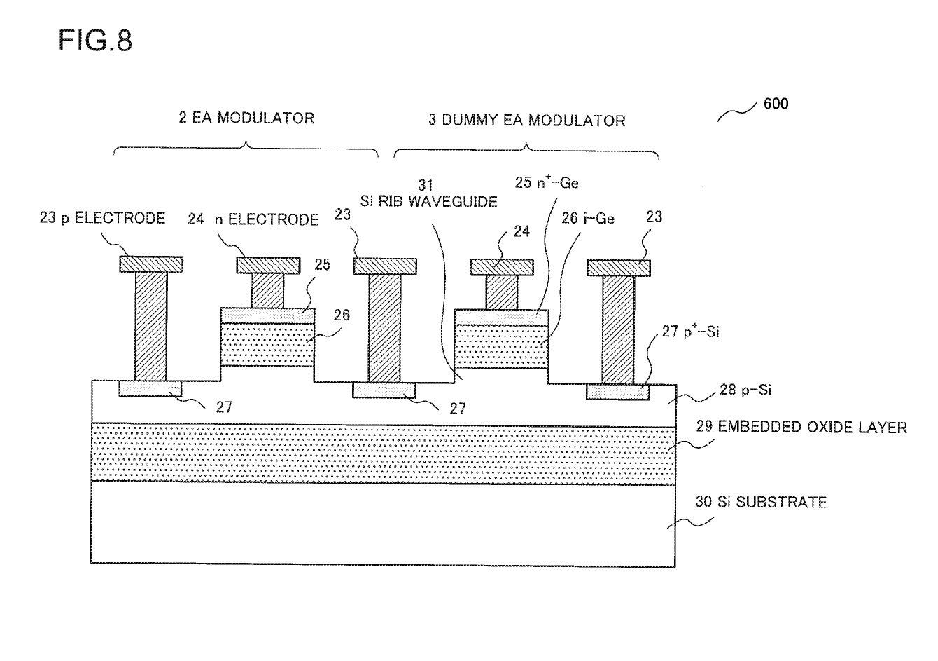

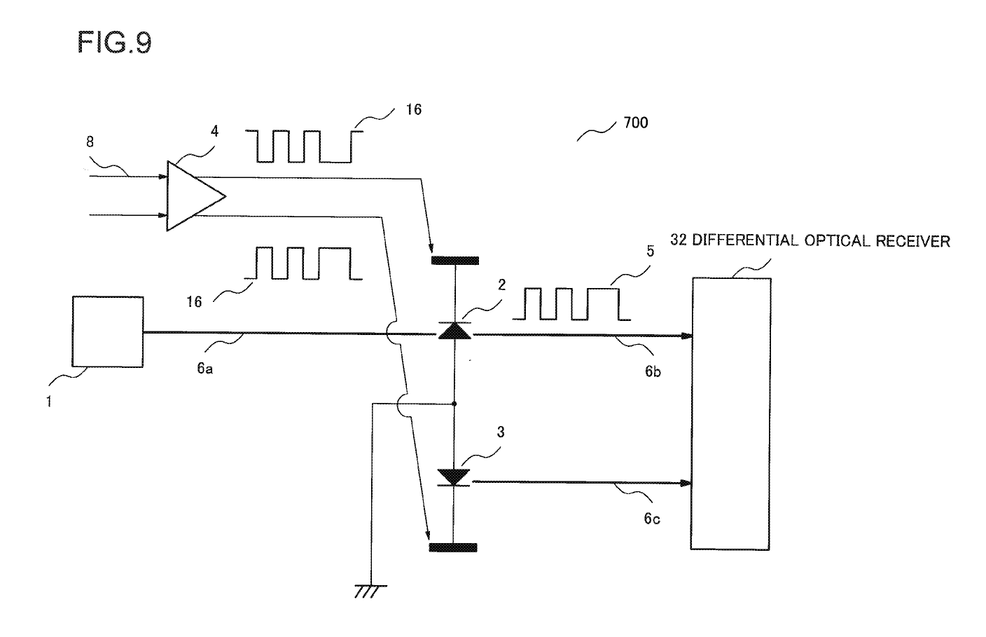

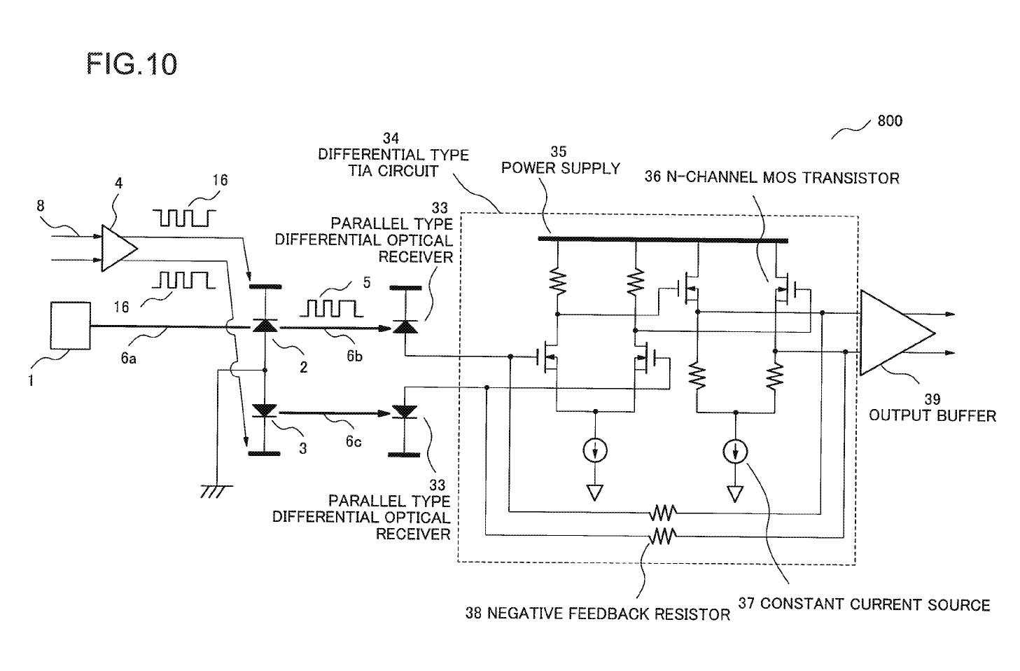

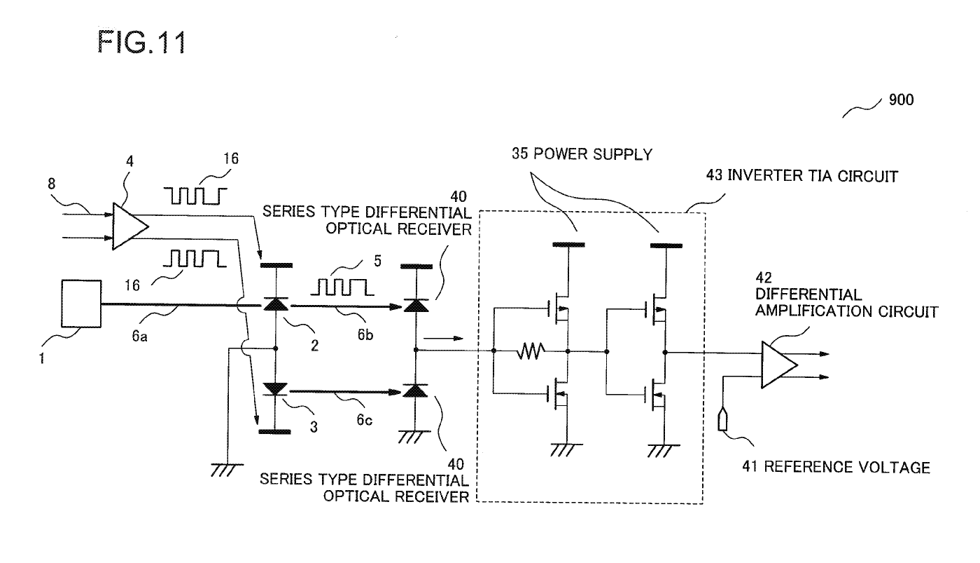

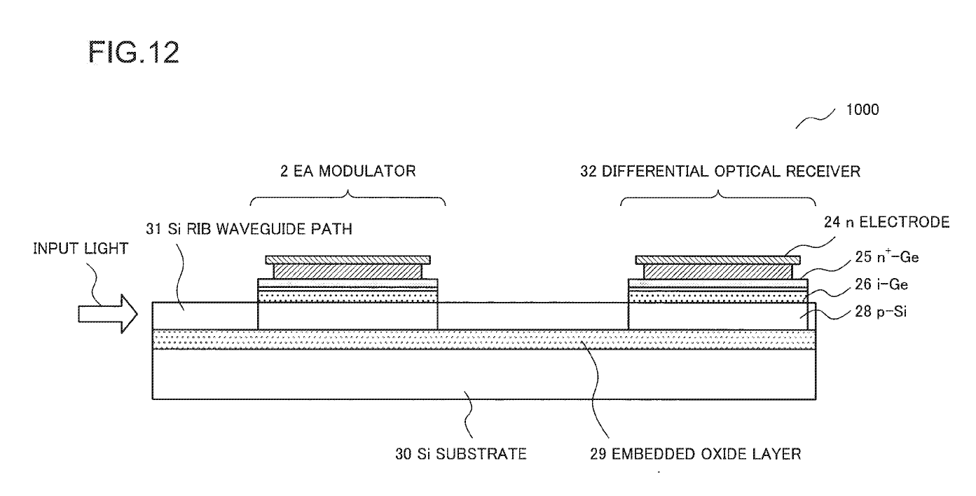

### BRIEF DESCRIPTION OF DRAWINGS

[FIG. 1] A diagram showing a configuration of an optical sending circuit of a first exemplary embodiment

[FIG. 2] A diagram showing the minimum configuration of the optical sending circuit of the first exemplary embodiment

[FIG. 3] A diagram showing a configuration of an optical sending circuit of a second exemplary embodiment

[FIG. 4] A diagram showing a configuration of an optical sending circuit of a third exemplary embodiment

[FIG. 5] A diagram showing a configuration of an optical sending circuit of a fourth exemplary embodiment

[FIG. 6] A diagram showing a configuration of an optical sending circuit of a fifth exemplary embodiment

[FIG. 7] A plan view of an EA modulation unit of a sixth exemplary embodiment

[FIG. 8] A cross section view of the EA modulation unit of the sixth exemplary embodiment

[FIG. 9] A diagram showing a configuration of an optical transmission system of a seventh exemplary embodiment

[FIG. 10] A diagram showing a configuration of an optical transmission system of an eighth exemplary embodiment

[FIG. 11] A diagram showing a configuration of an optical transmission system of a ninth exemplary embodiment

[FIG. 12] A diagram showing a cross section view of an optical sending circuit of a tenth exemplary embodiment

[FIG. 13] A diagram showing a configuration of an optical transmission system which is related to the present invention

### DESCRIPTION OF EMBODIMENTS

Next, an exemplary embodiment of the present invention will be described in detail with reference to a drawing.

### First Exemplary Embodiment

FIG. 1 is a diagram showing a configuration of an optical sending circuit of a first exemplary embodiment of the present invention. An optical sending circuit 100 includes the light source 1, the EA modulator 2, the dummy EA modulator 3, a driving circuit 4 and optical transmission lines 6a to 6c. The light source 1 generates a continuous light, which is modulated by the EA modulator 2, and outputs the generated continuous light. The continuous light, which is outputted by the light source 1, is propagated through the optical transmission line 6a, and is led to the EA modulator 2. Meanwhile, the data signal stream 8, which is outputted by a logic circuit (not shown in the drawing) or the like, is inputted to the driving circuit 4. The driving circuit 4 generates a differential electric signal 16 from the data signal stream 8. Then, one signal out of the generated differential electric signal 16 is inputted to the EA modulator 2 and the other signal is inputted to the dummy EA modulator 3. The differential electric signal 16 changes reverse bias voltages which are applied to the EA modulator 2 and the dummy EA modulator 3. Logical levels of two signals out of the differential electric signal, which are inputted to the EA modulator 2 and the dummy EA modulator 3, are reverse each other. At this time, in addition to the differential electric signal 16, direct current (DC) bias voltages may be applied to the EA modulator 2 and the dummy EA modulator 3. Moreover, the driving circuit 4 may output a differential signal which is generated by adding DC bias voltage to the differential electric signal 16.

As shown in FIG. 1, the continuous light from the light source 1 is inputted only to the EA modulator 2 through the optical transmission line 6a, and the continuous light from the light source 1 is not inputted to the dummy EA modulator 3. Accordingly, modulation of the continuous light, which is outputted by the light source, by the differential electric signal 16 is carried out only in the EA modulator 2. Then, the modulated optical signal 5 is outputted only to the optical transmission line 6b.

The optical transmission lines 6b and 6c are connected with an optical receiver not shown in the drawing. Accordingly, the modulated signal, which is generated by the EA modulator 2, is transmitted toward the optical receiver through the optical transmission line 6b. However, since the dummy EA modulator 3 does not input the light from the light source 1, the optical receiver does not receive the modulated optical signal 5 through the optical transmission line 6c.

Meanwhile, there is a case that the stray light from the outside and the cross talk light, which leaks from another optical transmission line, intrude into the optical transmission lines 6b and 6c. The stray light and the cross talk light mentioned above degrade the signal to noise ratio of the modulated signal.

The optical receiver does not receive the modulated optical signal 5 through the optical transmission line 6c which is connected with the dummy EA modulator 3. However, the stray light and the cross talk light intrude into the optical transmission line 6c similarly to the optical transmission line 6b. Therefore, the optical receiver detects common-mode noise components, which are caused by the stray light and the cross talk light, through the optical transmission lines 6b and 6c respectively. Accordingly, it is possible to suppress the noise component which is caused by the stray light and the cross talk light, and to improve receiving sensitivity of the optical receiver by the optical receiver's detecting a difference between outputs of the optical transmission lines 6b and 6c.

That is, the optical sending circuit 100, which uses the dummy EA modulator 3, can improve the receiver sensitivity of the optical receiver in comparison with a case that the optical sending circuit 100 uses the single optical transmitter described in FIG. 13, that is, the optical receiver receives only the modulated optical signal 5 which is received from the optical transmission path 6c.

Moreover, according to the optical sending circuit 100, since the optical receiver detects a difference between intensity of light which is outputted from the optical transmission line 6b, and intensity of light which is outputted from the optical transmission line 6c, it is unnecessary that the optical receiver includes a circuit for carrying out the single-differential conversion.

Furthermore, according to the optical sending circuit 100, it is unnecessary that the dummy EA modulator 3 inputs the light from the light source. Accordingly, according to the optical sending circuit 100, in comparison with the differential optical transmitter, it is unnecessary to use a branch circuit which divides the light, which is inputted from the light source, into two branches toward the EA modulator 2 and the dummy EA modulator 3. Therefore, according to the optical sending circuit 100, in comparison with the differential optical transmitter, it is possible to make the optical sending circuit miniaturized and it is also possible to make an optical output of each EA modulator about 2 times larger. As a result, the optical sending circuit 100 provides an effect that it is possible to suppress the noise component, which is caused by the stray light and the cross talk light, similarly to the differential optical transmitter. Furthermore, the optical sending circuit 100 provides an effect that it is possible to make the optical sending circuit 100 miniaturized and to carry out long haul transmission by sending the modulated optical signal 5 whose optical output power is about 2 times larger than the optical output power of the differential optical transmitter.

As mentioned above, the optical sending circuit 100 of the first exemplary embodiment provides an effect that it is possible to make the optical sending circuit 100 miniaturized and to carry out long haul transmission and it is possible to reduce the stray light and the optical cross talk noise which are generated through the optical transmission line.

By the way, if the differential electric signal 16, which is outputted by the driving circuit 4, is supplied only to the EA modulator 2, balance of an EA modulator 2 side load of the driving circuit 4 and a dummy EA modulator side load of the driving circuit 4 is lost. In this case, since a differential circuit of the driving circuit 4 cannot work in a suitable condition, there is a fear that an electric noise, which is generated in the driving circuit 4, cannot be canceled by the driving circuit 4.

In contrast, the optical sending circuit 100 inputs one signal out of the differential electric signal 16, which is outputted from the driving circuit 4, to the EA modulator 2, and inputs the other signal to the dummy EA modulator 3. Therefore, according to the optical sending circuit 100, the load balance of the driving circuit 4 is maintained. As a result, noise of the driving circuit 4 is reduced by the differential operation of the driving circuit 4.

When realizing the optical sending circuit 100, an implementation form, an integration form or material of a component such as the light source 1, the EA modulator 2, the dummy EA modulator 3, the driving circuit 4 and the optical transmission lines 6a to 6c has no limitation in particular. For example, it is possible to make the optical sending circuits 100 miniaturized furthermore by integrating these components on a SOI (Silicon on Insulator) substrate and a group III-V compound semiconductor substrate such as InP (indium-phosphorus) or GaAs (gallium-arsenic).

In the optical sending circuit 100, the light source 1 may be integrated on the same chip as the EA modulator 2 and the dummy EA modulator 3 are integrated. Or, the optical sending circuit 100 may have a configuration that the light source 1 is installed outside the chip, and the light from the light source is introduced to the optical transmission line, which is integrated on the chip, by a grating coupler, a spot size converter or the like through an optical fiber, a polymer waveguide path or the like.

In the case that the EA modulator 2 and the dummy EA modulator 3 are formed on the SOI substrate, SiₓGe₁₋ₓ (0≦x≦1) to which epitaxial growth on Si is applied may be used as an absorption layer. A composition ratio x in a SiₓGe₁₋ₓ light absorption layer is selected suitably in consideration of an incident light wavelength and a driving method. For example, the composition ratio x may be determined so that an extinction ratio may become large. Moreover, the EA modulator may be formed by use of group III-V compound semiconductor which is stuck on the SOI substrate.

Furthermore, each of the EA modulator 2 and the dummy EA modulator 3 may be an EA modulator which uses the Franz-Keldysh effect of the bulk semiconductor or may be an EA modulator which uses the quantum-confined Stark effect of the multi-quantum well.

In FIG. 1, the EA modulator 2 and the dummy EA modulator 3 are connected with the common ground. However, a configuration of the EA modulator is not limited to the above, and the EA modulator 2 and the dummy EA modulator 3 may be connected with the grounds different each other.

Due to variation of characteristic of the EA modulator, the extinction ratio is different per the EA modulator. However, it is possible to obtain the optimum extinction ratio by adjusting a bias voltage which is applied to the EA modulator 2.

Each of the optical transmission lines 6a to 6c may be an optical waveguide path formed on a chip or an optical fiber connected separately, or may be a combination of those components. In the case of using the SOI substrate, it is possible to form a small optical circuit by using a Si waveguide path which includes Si as a core. Moreover, each of the optical transmission lines 6a to 6c may be a waveguide path which includes Si_{y}Ge_{1-y} (0≦y≦1) as a core. In this case, the optical transmission lines 6a to 6c may be formed on a bulk Si substrate. Moreover, by setting y to be larger than x, that is, by making a Si composition ratio of the optical transmission lines 6a to 6c larger than a Si composition ratio of the EA modulator, it is possible to realize an optical sending circuit whose propagation loss of waveguide path is small and whose light transmission efficiency is high.

The driving circuit 4 may be integrated on the same chip as the EA modulator 2 and the dummy EA modulator 3 are integrated, or may be formed on another chip.

Moreover, the optical sending circuit 100 may have a configuration that information (for example, intensity and/or phase) on the modulated optical signal 5, which is outputted from the optical transmission line 6b, is fed back to the bias voltages which are provided to the EA modulator 2 and the dummy EA modulator 3, and is fed back to an output voltage of the driving circuit 4. By the configuration of carrying out the above-mentioned feedback, the optical sending circuit 100 can control a voltage of the differential electric signal 16 and the bias voltage dynamically on the basis of a state of the modulated optical signal 5.

Furthermore, it is also possible to compose an optical communication device which uses the optical sending circuit 100 in a signal transmission unit. Or, it is also possible to compose an optical interconnection module by forming the optical sending circuit of the present invention on a Si substrate or a SOI substrate, and integrating an electronic circuit, which is integrated into a large-scale-integration (LSI), on the same substrate monolithically.

Here, according to the above explanation on the optical sending circuit 100, the driving circuit 4 inputs one signal and the other signal out of the differential electric signal 16, whose phases are reverse each other, to the EA modulator 2 and the dummy EA modulator 3 respectively. However, the signal which is inputted from the driving circuit 4 to the EA modulator 2, and the signal which is inputted from the driving circuit 4 to the dummy EA modulator 3 may have phases which are not reverse each other. In this case, the EA modulator 2 modulates a light to be modulated according to the signal, which is inputted from the driving circuit 4, and consequently the modulated optical signal 5 is generated. Then, the modulated optical signal 5 is transmitted through the optical transmission line 6b, and is received by the optical receiver. On the other hand, the modulated optical signal is not inputted to the optical transmission line 6c from the dummy EA modulator 3 with no relation to contents of the signal which is inputted to the dummy EA modulator 3 from the driving circuit 4. Even in this case, since common mode noise caused by the stray light and the cross talk light is received through the optical transmission lines 6b and 6c, it is possible to suppress the noise component, which is caused by the stray light and the cross talk light, by the optical receiver's detecting a differential component, and consequently it is possible to improve the receiving sensitivity of the optical receiver.

Accordingly, it is possible to make the optical sending circuit 100 miniaturized and to carry out long haul transmission even in the case that the signals which are inputted to the EA modulator 2 and the dummy EA modulator 3 respectively have the phases which are not reverse each other. Then, the optical sending circuit 100 provides an effect that it is possible to reduce the stray light and the optical cross talk noise which are generated through the optical transmission line.

By the way, the effect which the optical sending circuit 100 of the first exemplary embodiment provides is also provided by an optical sending circuit 101 shown in FIG. 2. FIG. 2 is a diagram showing the minimum configuration of the optical sending circuit 101 of the first exemplary embodiment. That is, the optical sending circuit 101 includes the EA modulator 2, the dummy EA modulator 3 and the optical transmission lines 6a to 6c. The EA modulator 2 is driven by one signal out of the differential electric signal 16. The dummy EA modulator 3 is driven by the other signal out of the differential electric signal 16. The continuous light, which is to be modulated by the EA modulator 2, is inputted to the EA modulator 2 through the optical transmission line 6a. The optical transmission line 6b is connected with the output of the EA modulator 2, and transfers the modulated signal 5 which is obtained through modulation by use of one signal of the differential electric signal 16. The optical transmission line 6c is connected with the output of the dummy EA modulator 3.

Also in the case that an optical signal is transmitted by use of the optical transmitter 101 having the above-mentioned configuration, the optical receiver detects the common mode noise, which is caused by the stray light and the cross talk light, through the optical transmission lines 6b and 6c. Accordingly, the optical transmitter 101 makes it possible to suppress the noise component caused by the stray light and the cross talk light and to improve the receiving sensitivity of the optical receiver by the optical receiver's detecting a difference between the outputs of the optical transmission lines 6b and 6c. Accordingly, also the optical sending circuit 101 provides an effect that it is possible to make the optical sending circuit 101 miniaturized and to carry out long haul transmission and it is possible to reduce the stray light and the optical cross talk noise which are generated through the optical transmission line.

### Second Exemplary Embodiment

FIG. 3 is a diagram showing a configuration of an optical sending circuit 200 of a second exemplary embodiment of the present invention. The optical sending circuit 200 includes the light source 1, the EA modulator 2, the dummy EA modulator 3, the optical transmission lines 6a to 6c and a driving circuit 9. Here, an element which is shown in the drawing and has been described already, is assigned the same reference number, and overlapping explanation is omitted.

The optical sending circuit 200 is different from the optical sending circuit 100 of the first exemplary embodiment in points that the optical sending circuit 200 includes the driving circuit 9 which outputs an electric signal 10 of a single end signal and that the EA modulator 2 and the dummy EA modulator 3 are connected in series.

According to the optical sending circuit 200, a positive electrode (cathode) of the EA modulator 2 is connected with a bias power supply Vb, and a negative electrode (anode) of the dummy EA modulator 3 is connected with the ground. An anode of the EA modulator 2 and a cathode of the dummy EA modulator 3 are connected each other electrically through a common electrode. That is, electric potential of the electrode (cathode) of the EA modulator 2, which is opposite to the common electrode, is fixed to the bias voltage. On the other hand, electric potential of the electrode (anode) of the dummy EA modulator 3, which is opposite to the common electrode, is fixed to the ground level. Therefore, by inputting the electric signal 10 from the driving circuit 9 to the common electrode, the EA modulator 2 and the dummy EA modulator 3 are driven by the electric signal so that the electric signal may work as a normal phase signal for the EA modulator 2 and may work as a reverse phase signal for the dummy EA modulator 3. Here, the light from the light source 1 is not input to the dummy EA modulator 3. As a result, a modulated optical signal, which is obtained through modulation by use of the electric signal 10, is outputted only from the optical transmission line 6b similarly to the first exemplary embodiment.

According to the optical sending circuit 200, by supplying the electric signal 10, which is the single end signal, at a connection point where the EA modulator 2 and the dummy EA modulator 3 are connected in series, the EA modulator 2 and the dummy EA modulator 3 are driven by the electric signal 10 simultaneously. Therefore, even in the case that the data signal stream 8 is the single end signal, the optical sending circuit 200 has no necessity to include the single-differential conversion circuit and consequently the optical sending circuit 200 provides an effect that it is possible to make the circuit configuration simplified.

Here, except for the point that the EA modulator 2 and the dummy EA modulator 3 are connected in series, the configuration and the fundamental operation of the optical sending circuit 200 are the same as ones of the optical sending circuit 100 of the first exemplary embodiment. Accordingly, similarly to the optical sending circuit 100 of the first exemplary embodiment, the optical sending circuit 200 provides an effect that it is possible to make the optical sending circuit miniaturized and to carry out long haul transmission, and it is possible to reduce the stray light and the optical cross talk noise which are generated through the optical transmission line.

### Third Exemplary Embodiment

FIG. 4 is a diagram showing a configuration of an optical sending circuit 300 of a third exemplary embodiment of the present invention. The optical sending circuit 300 includes a bias controller 18 in addition to the optical sending circuit 100 which is explained in the first exemplary embodiment.

The bias controller 18 monitors the light absorption current 11 which flows from the EA modulator 2 to the ground. Then, the bias controller 18 controls the driving circuit 4 on the basis of an ON/OFF ratio of the monitored light absorption current. Specifically, the bias controller 18 controls a DC bias voltage, which the driving circuit 4 adds to the differential electric signal 16, dynamically on the basis of the ON/OFF ratio of the light absorption current.

Here, when the extinction ratio of the optical signal, which is outputted by the EA modulator 2, becomes low, also the ON/OFF ratio of the light absorption current 11 becomes low. Therefore, the optical sending circuit 300 provides an effect that, by controlling the DC bias voltage suitably on the basis of the ON/OFF ratio of the light absorption current 11, it is possible to maintain the extinction ratio of the optical signal, which is outputted by the EA modulator 2, in a desirable state.

Here, except for the bias controller 18, the configuration and the fundamental operation of the optical sending circuit 300 are the same as ones of the optical sending circuit 100 of the first exemplary embodiment. Accordingly, similarly to the optical sending circuit 100 of the first exemplary embodiment, also the optical sending circuit 300 provides an effect that it is possible to make the optical sending circuit miniaturized and to carry out long haul transmission, and it is possible to reduce the stray light and the optical cross talk noise which are generated through the optical transmission line.

Moreover, the optical sending circuit 300 has no necessity that an optical branch unit or an optical receiver is arranged at a halfway position of the optical sending circuit 6b in order to monitor the extinction ratio of an optical signal. Therefore, the optical sending circuit 300 provides also an effect that a configuration of the optical transmission line 6b is simple in comparison with a configuration that an optical receiver which is used for monitoring is arranged at a halfway position of the optical transmission line 6b, and branch loss, which may be caused by the optical branch unit used for the optical receiver, is not caused.

### Fourth Exemplary Embodiment

FIG. 5 is a diagram showing an optical sending circuit 400 of a fourth exemplary embodiment of the present invention. The optical sending circuit 400 of the fourth exemplary embodiment has a configuration which is obtained by adding a temperature controller 19 and a temperature adjusting element 20 to the optical sending circuit 100 explained in the first exemplary embodiment.

The optical sending circuit 400 inputs a signal, which is a result of monitoring the light absorption current 11 generated in the EA modulator 2, to the temperature controller 19, and controls temperature of a semiconductor element, on which the EA modulator 2 is formed, dynamically by use of the temperature adjusting element 20 so that the temperature may become optimum.

Since a band gap of a semiconductor element is changed by variation of temperature, an extinction ratio of an optical signal also varies with the variation of temperature. In order to secure stable operations of the EA modulator 2 and the dummy EA modulator 3 even when ambient temperature varies, it is desirable that temperatures of the EA modulator 2 and the dummy EA modulator 3 are kept constant. The optical sending circuit 400 of the fourth exemplary embodiment monitors the light absorption current 11 similarly to the optical sending circuit 300 of the third exemplary embodiment. Then, according to the optical sending circuit 400, the temperatures of the EA modulator 2 and the dummy EA modulator 3 are controlled dynamically on the basis of a change in the extinction ratio which is found on the basis of the light absorption current 11. As the temperature adjusting element 20, for example, a Peltier element is applicable. As a result, the optical sending circuit 400 provides an effect that, even in the case that the ambient temperature varies, it is possible to always obtain the optimum extinction ratio.

Here, except for the temperature controller 19 and the temperature adjusting element 20, the configuration and the operation of the optical sending circuit 400 are the same as ones of the optical sending circuit 100 of the first exemplary embodiment. Accordingly, similarly to the optical sending circuit 100 of the first exemplary embodiment, also the optical sending circuit 400 provides an effect that it is possible to make the optical sending circuit miniaturized and to carry out long haul transmission, and it is possible to reduce the stray light and the optical cross talk noise which are generated through the optical transmission line.

### Fifth Exemplary Embodiment

FIG. 6 is a diagram showing a configuration of an optical sending circuit 500 of a fifth exemplary embodiment of the present invention. The optical sending circuit 500 of the fifth exemplary embodiment has a configuration which is obtained by adding an output controller 22 to the optical sending circuit 100 explained in the first exemplary embodiment. Except for the output controller 22, a configuration and an operation of the optical sending circuit 500 are the same as ones of the optical sending circuit 100 of the first exemplary embodiment. Accordingly, similarly to the optical sending circuit 100 of the first exemplary embodiment, the optical sending circuit 500 provides an effect that it is possible to make the optical sending circuit miniaturized and to carry out long haul transmission, and it is possible to reduce the stray light and the optical cross talk noise which are generated through the optical transmission line.

The optical sending circuit 500 monitors the light absorption current 11 which is generated in the EA modulator 2 and the dummy EA modulator 3, and inputs the monitor signal to the output controller 22. The output controller 22 controls dynamically optical power, which is outputted by the light source 1, on the basis of the monitored light absorption current 11.

As a light which passes the EA modulator 2 becomes intense, the light absorption current 11, which is outputted by the EA modulator 2, becomes strong. Therefore, the output controller 22 can carry out feedback control to light intensity of the light source 1 so as to send optical power not smaller than a threshold value which is required for the optical receiver's carrying out a normal 1/0 signal decision. Moreover, the output controller 22 can prevent the light source 1 from outputting the optical power stronger than necessary optical power. As a result, in addition to the effect which the optical sending circuit 100 of the first exemplary embodiment provides, the optical sending circuit 500 of the fifth exemplary embodiment provides an effect that it is possible to suppress power consumption of the light source by supplying optical power which is necessary and sufficient for receiving a signal.

Here, a value of the optical power of the modulated optical signal 5 which is required for receiving data normally, and strength of the light absorption current 11, which is corresponding to the value of the optical power, may be held in advance in a record area which is arranged in the optical sending circuit 500. Moreover, the optical sending circuit 500 may receive notification on a receiving condition from an opposite optical receiver, and control the power of the light source 1 on the basis of contents of the notification. As the notification on the receiving condition, for example, a situation of error generation, a signal to noise ratio or required sending power is exemplified. But the present invention is not limited to the above.

### Sixth Exemplary Embodiment

FIG. 7 is a plan view of an EA modulation unit 600 of a sixth exemplary embodiment of the present invention. The EA modulation unit 600 has a configuration which includes the optical transmission lines 6a to 6c, the EA modulator 2 and the dummy EA modulator 3 of the optical sending circuits 100, 300, 400 and 500 which have been explained with reference to FIG. 1, FIG. 4, FIG. 5 and FIG. 6.

In FIG. 7, the input light from the light source 1 (not shown in the drawing) is propagated through the optical transmission line 6a and is inputted to a lower part of an n electrode 24 of the EA modulator 2. The input light is modulated by the EA modulator 2, and consequently the modulated optical signal 5 is generated. Each of the optical transmission lines 6a to 6c shown in FIG. 7 is the Si rib waveguide.

FIG. 8 is a cross section of the EA modulation unit 600. The EA modulator 2 has semiconductor lamination structure including n⁺-Ge 25, i-Ge 26, p⁺-Si 27 and p-Si 28, and includes a n electrode 24 which is connected with n⁺-Ge 25, and a p electrode 23 which is connected with p⁺-Si 27. Composition of the dummy EA modulator 3 is similar to one of the EA modulator 2.

I-Ge 26, which is the light absorption layer, is formed on a Si rib waveguide 31, and a part of light which is propagated through the Si rib waveguide 31 moves to i-Ge 26 by evanescent coupling. Moreover, an embedded oxide layer 29, which is formed on a Si substrate 30, exists under the Si rib waveguide 31, and works as a clad. FIG. 8 shows the EA modulation unit 600 including the p electrode 23 which is arranged at a midpoint between two EA modulators (EA modulator 2 and dummy EA modulator 3) and which is a common part of two EA modulators. However, the p electrode may be formed in the EA modulator 2 and in the dummy EA modulator 3 separately.

Moreover, while device structure that Ge is used as material of the absorption layer is shown, material which is used for forming the differential EA modulator according to the present invention is not limited in particular. Moreover, while vertical type PIN (P-Intrinsic-N) structure is exemplified in FIG. 8 as the device structure of the EA modulator, the structure of the EA modulator may be horizontal type PIN structure. Moreover, joint structure between the optical transmission line 6b and the EA modulator 2, and between the optical transmission line 6c and the dummy EA modulator 3 has no limitation, and for example, the butt joint may be applicable.

### Seventh Exemplary Embodiment

FIG. 9 is a diagram showing a configuration of an optical transmission system 700 of a seventh exemplary embodiment of the present invention. The optical transmission system 700 of the seventh exemplary embodiment includes the optical sending circuit 100 of the first exemplary embodiment and a differential optical receiver 32. The differential optical receiver 32 is arranged at end points of two optical transmission lines 6b and 6c. The differential optical receiver 32 converts light signals, which are outputted from the optical transmission lines 6b and 6c, into a differential electric signal. Here, the optical transmission line 6b outputs the noise, which is caused by the stray light and the optical cross talk, in addition to the modulated optical signal 5. On the other hand, the optical transmission line 6c outputs only the noise which is caused by the stray light and the optical cross talk. Then, the differential optical receiver 32 removes an in-phase component of the noise which is caused by the stray light and the optical cross talk.

Since the optical transmission system 700 includes the differential optical receiver 32, the optical transmission system 700 has no necessity to carry out the single-differential conversion of the electric signal. As a result, it is easy to design the optical transmission system 700 and to make the optical transmission system 700 miniaturized. Furthermore, the optical transmission system 700 provides an effect that, since the differential optical receiver 32 cancels the in-phase component of noise caused by the stray light and the optical cross talk which intrudes commonly into the optical transmission lines 6b and 6c, the receiving sensitivity is improved.

That is, similarly to the optical sending circuit 100 of the first exemplary embodiment, the optical sending circuit 700 provides an effect that it is possible to make the optical sending circuit miniaturized and to carry out long haul transmission, and it is possible to reduce the stray light and the optical cross talk noise which are generated through the optical transmission line.

Furthermore, according to the optical transmission system 700, it is also possible to realize a long haul optical transmission system, in which the differential optical receiver 32 is arranged at a remote location, by using a long distance optical fiber as the optical transmission lines 6b and 6c.

Meanwhile, the EA modulator 2, the dummy EA modulator 3 and the differential optical receiver 32 may be formed on the same substrate. The optical transmission system 700, which has the configuration mentioned above, is used as an optical interconnection module in which the driving circuit 4 and the differential optical receiver 32 are electrically insulated each other.

The differential optical receiver 32 includes two internal optical receivers. As will be explained later in an eighth and a ninth exemplary embodiments, these optical receivers may be connected in parallel electrically or may be arranged in series. Moreover, in the case that the differential optical receiver 32 is formed on the same substrate as the EA modulator 2 and the dummy EA modulator 3 are formed, it is possible to simplify a fabrication process by forming the differential optical receiver 32 with semiconductor material which is the same as material of the EA modulator 2 and dummy EA modulator 3.

### Eighth Exemplary Embodiment

FIG. 10 shows a configuration of an optical transmission system 800 which is an eighth exemplary embodiment of the present invention. The optical transmission system 800 includes a parallel type differential optical receiver 33 as the differential optical receiver 32 of the optical transmission system 700 according to the seventh exemplary embodiment, and includes furthermore a differential type transimpedance amplification (hereinafter, referred to as ‘TIA’) circuit 34 and an output buffer 39.

According to the optical transmission system 800, a differential light signal is converted into a differential electric signal by the parallel type differential optical receiver 33 in which two optical receivers are arranged in parallel. Then, the differential type TIA circuit 34, which is arranged at the rear of the parallel type differential optical receiver 33, converts a current signal, which is inputted from the parallel type differential optical receiver 33, into a voltage signal and amplifies the voltage signal. The differential type TIA circuit 34 includes a power supply 35, an N-channel MOS transistor 36, a constant current source 37 and a negative feedback resister 38. An output signal of the differential type TIA circuit 34 is transferred through the output buffer 39 to a logic circuit or the like which is arranged at the rear of the output buffer 39.

By virtue of a work which is similar to the work of the optical sending circuit 700 of the seventh exemplary embodiment, also the optical sending circuit 800 having the above-mentioned configuration provides an effect that it is possible to make the optical sending circuit miniaturized and to carry out long haul transmission, and it is possible to reduce the stray light and the optical cross talk noise which are generated through the optical transmission line.

The differential type TIA circuit 34 may be integrated monolithically on the same substrate as the parallel type differential optical receiver 33 is integrated. Or, a substrate on which the differential type TIA circuit 34 is mounted, and a substrate on which the parallel type differential optical receiver 33 is mounted may be fabricated separately, and the differential type TIA circuit 34 and the parallel type differential optical receiver 33 may be laminated by use of flip chip mounting and a Si through via hole. In this case, the differential type TIA circuit 34 may be formed on the same chip as the driving circuit 15 is formed. Moreover, it is also possible to realize an optical transmission system which is capable of multi-channel transmission by integrating a plurality of the light sources 1, the EA modulators 2, the dummy EA modulators 3, the parallel type differential optical receivers 33, the differential type TIA circuits 34 and the driver circuits 15.

Here, FIG. 10 shows a specific example of a circuit which uses a differential amplifier. However, a circuit, which amplifies the signal outputted by the differential optical receiver, is not limited to the above, and differential signal amplification can be carried out suitably by the optimum circuit configuration.

### Ninth Exemplary Embodiment

FIG. 11 shows an optical transmission system 900 of a ninth exemplary embodiment of the present invention. The optical transmission system 900 is different from the optical transmission system 800 of the eighth exemplary embodiment in a point that a series type differential optical receiver 40, in which two optical receivers are connected in series, converts a differential light signal into an electric signal, and an inverter type TIA circuit 43 which is arranged at the rear of the series type differential optical receiver 40 amplifies the electric signal.

By virtue of a work which is similar to the work of the optical sending circuits 700 and 800 of the seventh and the eighth exemplary embodiments respectively, also the optical sending circuit 900 having the above-mentioned configuration provides an effect that it is possible to make the optical sending circuit miniaturized and to carry out long haul transmission, and it is possible to reduce the stray light and the optical cross talk noise which are generated through the optical transmission line.

An output signal of the inverter type TIA circuit 43 is converted into a differential signal by a differential amplification circuit 42 which uses a reference voltage 41. Since it is possible to obtain a large transimpedance gain by using an inverter, a small TIA circuit is realized. Moreover, it is also possible to determine the reference voltage by use of a series type differential optical receiver which is dummy, that is, which has the same structure as the series type differential optical receiver 40 has, but does not input the optical signal.

Moreover, in the case that the inverter type TIA circuit includes a CMOS inverter as the inverter, when input signal amplitude whose central value is an inverter threshold value is not obtained, linearity and gain of the inverter type TIA circuit are degraded. Therefore, there is a case that a rising/falling waveform becomes asymmetry, and consequently the eye pattern includes distortion. As a result, in the case that the single end transmission for which one EA modulator and one optical receiver are used is carried out, there is a case that the minimum receiving sensitivity is degraded.

Since the series type differential optical receiver 40 is used in the ninth exemplary embodiment, an electric current with a normal phase and an electric current with a reverse phase are inputted to the inverter type TIA circuit, and input amplitude whose central value is the inverter threshold value is obtained. As a result, the inverter type TIA circuit 43 provides an effect that, in comparison with the single end transmission, the linearity and the gain are improved, and distortion of the eye pattern is canceled since the symmetrical rising/falling waveform is obtained.

### Tenth Exemplary Embodiment

FIG. 12 is a diagram showing a cross section view of an optical transmission module 1000 of a tenth exemplary embodiment of the present invention. FIG. 12 shows a cross section of device structure along a path on which the input light is propagated in the case that the EA modulator 2, the dummy EA modulator 3 and the differential optical receiver 32 of the optical transmission system 700 of the seventh exemplary embodiment shown in FIG. 9 are integrated on the same semiconductor substrate. The input light is converted into the electric signal by the differential optical receiver which is formed on the same substrate.

Since it is possible to compose the EA modulator 2 and the optical receiver 32 which have the same device structure, it is possible to fabricate the EA modulator 2 and the optical receiver 32 together in a common process. Also the dummy EA modulator 3 which is not shown in FIG. 12 may be fabricated in the same process as the EA modulator 2 is fabricated. Moreover, even in the case that the same absorption layer material is applied to the EA modulator 2 and the optical receiver 32, it is possible to make an absorption length of the optical receiver 32 short together with making the extinction ratio of the EA modulator large by optimizing the bias voltages which are applied to the EA modulator 2 and the optical receiver 32 respectively. For example, when forming the EA modulator and the optical receiver together by use of SiGe as the absorption layer, it is possible to form a high efficient optical circuit by controlling the material composition ratio and the distortion of the EA modulator and the optical receiver.

While the invention has been explained with reference to the first to the tenth exemplary embodiments, the invention is not limited to these exemplary embodiments. It is possible to add various changes, which can be understood by those of ordinary skill in the art, to the composition and details of the invention of the present application within the scope of the invention of the present application.

For example, it is possible to realize an optical sending circuit which includes a combination of plural configurations in which the feedback is carried out by use of the light absorption current as described in FIGS. 4 to 6. Moreover, it is also possible to apply the configurations shown in FIG. 4 to FIG. 6 to the optical communication systems shown in FIG. 9 to FIG. 11.

This application is based upon and claims the benefit of priority from Japanese Patent Application No. 2010-188834, filed on Aug. 29, 2012, the disclosure of which is incorporated herein in its entirety by reference.

### REFERENCE SIGNS LIST

1 light source

2 EA modulator

3 dummy EA modulator

4 and 9 diving circuit

5 modulated optical signal

6, and 6a to 6c optical transmission line

7 optical receiver

8 data signal stream

10 electric signal

11 light absorption current

16 differential electric signal

18 bias controller

19 temperature controller

20 temperature adjusting device

23 p electrode

24 n electrode

25 n⁺-Ge

26 i-Ge

27 p⁺-Si

28 p-Si

29 embedded oxide layer

30 Si substrate

31 Si rib waveguide

32 differential optical receiver

33 parallel type differential optical receiver

34 differential type TIA circuit

35 power supply

36 N-channel MOS transistor

37 constant current source

38 negative feedback resistor

39 output buffer

40 series type differential optical receiver

41 reference voltage

42 differential amplification circuit

43 inverter type TIA circuit

100, 101, 200, 300, 400 and 500 optical sending circuit

600 EA modulation unit

700, 800 and 900 optical transmission system

1000 optical transmission module

What is claimed is:

1. An optical sending circuit, comprising:
a first semiconductor electro absorption type optical modulator (EA modulator) whose first reverse bias voltage is changed by a first data signal;
a second EA modulator whose second reverse bias voltage is changed by a second data signal;
a first optical transmission line which inputs a light to be modulated, which is to be modulated by the first EA modulator, to the first EA modulator;
a second optical transmission line which is connected with an output of the first EA modulator and transfers an optical signal which is modulated by the first data signal; and
a third optical transmission line which is connected with an output of the second EA modulator.

2. The optical sending circuit according to claim 1, wherein the second data signal has a phase which is reverse to a phase of the first data signal.

3. The optical sending circuit according to claim 1, wherein
the first and the second EA modulators are connected in series; and
the first and the second data signal are signals branching from a third data signal, which is applied to a connection point between the first and the second EA modulators, toward the first and the second EA modulators respectively.

4. The optical sending circuit according to claim 1, further comprising:
a control unit which controls at least one of the first and the second reverse bias voltages, temperatures of the first and the second EA modulators and optical power of the light to be modulated on the basis of light absorption currents of the first and the second EA modulators.

5. An optical transmission system, comprising:
the optical sending circuit according to claim 1; and
a differential optical receiver which converts a difference between an amplitude of an optical signal outputted from the second optical transmission line, and an amplitude of an optical signal outputted from the third optical transmission line.

6. The optical transmission system according to claim 5, wherein a plurality of the first EA modulators, a plurality of the second EA modulators and a plurality of the differential optical receivers are formed on the same substrate.

7. An optical transmission system, comprising:
the optical sending circuit according to claim 1;
a light source which provides the optical sending circuit with the light to be modulated;
a differential optical receiver which converts a difference between an amplitude of an optical signal outputted from the second optical transmission line and an amplitude of an optical signal outputted from the third optical transmission line into an electric signal; and
a transimpedance amplification circuit which amplifies the electric signal outputted from the differential optical receiver are formed on the same substrate.

8. An optical sending method comprising:
making a first data signal change a reverse bias voltage of a first semiconductor electro absorption type optical modulator (EA modulator);
making a second data signal change a reverse bias voltage of a second EA modulator;
inputting a light to be modulated, which is to be modulated by the first EA modulator, to the first EA modulator through a first optical transmission line;
connecting a second optical transmission line with an output of the first EA modulator; and
connecting a third optical transmission line with an output of the second EA modulator.

9. An optical sending circuit, comprising:
a first semiconductor electro absorption type optical modulator (EA modulator) configured to change first reverse bias voltage of the first EA modulator by a first data signal;
a second EA modulator configured to change second reverse bias voltage of the second EA modulator by a second data signal;
a first optical transmission line configured to input a light to be modulated, which is to be modulated by the first EA modulator, to the first EA modulator;
a second optical transmission line configured to connect with an output of the first EA modulator and transfers an optical signal which is modulated by the first data signal; and
a third optical transmission line configured to connect with an output of the second EA modulator.
